(19) United States
(12) Patent Application Publication
(10) Pub. No.: US 2007/0084539 A1
(43) Pub. Date: Apr. 19, 2007

(54) Quick change device for the oscillating tool of a vibration welding machine

(76) Inventors: Norbert Junker, Hosbach (DE); Wilfried Lotz, Neuberg (DE)

Correspondence Address: SEYFARTH SHAW LLP, 131 S. DEARBORN ST., SUITE2400, CHICAGO, IL, 60603-5803, US

(21) Appl. No.: 11/529,890

(22) Filed: Sep. 29, 2006

(30) Foreign Application Priority Data
Oct. 14, 2005 (DE) 10 2005 049 283.5
Sep. 15, 2006 (EP) 06 019 349.7

(51) Int. Cl. B23K 1/06

(52) U.S. Cl. 156/73.1; 228/110.1; 228/1.1

(57) ABSTRACT

A quick change device for an oscillating tool that can be attached to the vibratory unit of a vibration welding machine. The quick change device comprises several clamp bodies, through which a vibratory plate of the vibratory unit and a tool plate of the tool are connected with each other in a force-fit manner. The clamp bodies are mounted in a movable manner on the machine frame or on the vibratory unit in order to be able to be displaced between clamping and opening positions for closing or opening the force-fit connection. According to a preferred embodiment, the actuating devices are made up of screws, which serve to both tighten and release the clamp bodies as well as to ensure the force-fit connection.

### BACKGROUND OF THE INVENTION

The present invention relates to a quick change device for the tool that can be attached to the vibratory unit of a vibration welding machine for receiving a work-piece half to be welded.

A vibration welding machine has an oscillating tool (upper tool) and a stationary counter piece (bottom tool) for the positive holding of the work-piece halves (plastic parts) to be welded. The change of the work pieces in production (e.g. in the case of a dashboard from left- to right-hand drive) usually also requires the change of the tools, which needs to take place quickly to save time.

While there are fast and simple change devices for the stationary tool (bottom tool), the change of the oscillating tool usually requires the release of many screw connections. Due to the great dynamic forces affecting the vibratory unit (typical acceleration values during the welding process are 50 to 300 g), the oscillating tool is connected in a force-fit manner with the vibratory unit via many screws. The release of these many screw connections requires a great amount of time.

Previous solutions e.g. have only provided for a release of the screws. The screws remained in the tool, whereby the time needed for the release and tightening of the screws was shortened. Another solution was the fast release of the screws using a compressed-air screwdriver or an electrically operated, autarkic wrench. However, the underlying problem still remained: mechanical release of screw connections and their defined tightening.

Although there have already been attempts at accelerating the changing of the oscillating tool through automation, these attempts have not yet proven useful in practice.

### SUMMARY OF THE INVENTION

An object of the present invention is to create a quick change device for an oscillating tool of a vibratory unit of a vibration welding machine for receiving a work-piece half to be welded, which allows to clamp and release the tool and thus to exchange the tool as quickly as possible.

The quick change device of the present invention comprises a vibratory plate, which is part of the vibratory unit, and a tool plate, which is part of the oscillating tool. Furthermore, the quick change device comprises at least two clamp bodies and associated actuating devices. The clamp bodies are mounted in a moveable manner on a stationary or oscillating part of the vibration welding machine and the actuating device can be displaced between a clamping position and an opening position. In the clamping position, the clamp bodies establish a force-fit connection between the vibratory plate and the tool plate, while they release the force-fit connection in the opening position.

According to a preferred embodiment of the invention, the actuating devices have screws, which are screwed into bore holes of the vibratory unit and are connected with the clamp bodies, in order to be able to tighten and release the clamp bodies upon actuation. Preferably, the screws simultaneously serve to ensure the force-fit connection between the vibratory plate and the tool plate through the clamp bodies.

In the simplest case, the screws are operated manually (using a torque wrench). In an automatic embodiment, one or more screwdrivers are provided and integrated into the vibration welding machine for actuating the screws. In each case, only a limited number of screws are required due to the use of the clamp bodies so that the changing of the oscillating tool can be performed relatively quickly and easily.

### BRIEF DESCRIPTION OF THE DRAWINGS

Exemplary embodiments of the invention are described in greater detail based on the drawings.

FIG. 1 shows a perspective view of a part of the oscillating head of a vibration welding machine;

FIG. 2 shows an enlarged top view of the oscillating head in FIG. 1;

FIG. 3 shows enlarged details A, B and C from FIG. 2;

FIG. 4 shows an enlarged cross-section through half of the oscillating head along line IV-IV in FIG. 2;

FIG. 5 shows an enlarged cross-section along line V-V in FIG. 2;

FIG. 6 shows a lateral view of the oscillating head of a modified embodiment;

FIGS. 7 and 8 show enlarged sectional views along arrows VII-VII in FIG. 6 of the clamp area in the clamping and opening positions;

FIGS. 9 and 10 show perspective views of a clamp body from opposite sides.

### DETAILED DESCRIPTION OF THE PREFERRED EMBODIMENTS

The drawings show an oscillating head 2 of a vibration welding machine (not described in greater detail), wherein the coils of the oscillating head have been omitted in order to simplify the drawing. Since the non-describe part of the vibration welding machine with machine frame, lift table, stationary tool (bottom tool) for receiving the stationary work-piece half, etc. can have a conventional design, it is not described in greater detail here.

The vibration head 2 has a stationary section in the shape of a bridge 4, which is mounted on the machine frame (not shown) via dampers 6. The bridge 4 is made up of a substantially rectangular frame part 8, to both sides of which are attached longitudinally running, bar-shaped frame parts 10.

The vibration head 2 comprises an oscillating section in the form of a vibratory unit 12, which includes a vibratory plate 14. The vibratory unit 12 and thus the vibratory plate 14 are suspended from the bridge 4 via leaf springs 16 such that the vibratory unit 12 can execute oscillations along an oscillation axis X (see FIG. 2) for the welding process.

The oscillating tool (upper tool) that can be attached to the vibratory unit 12, which serves to receive the oscillating work-piece half to be welded (not shown), comprises a tool plate 18, to which the work-piece-specific adapter for the work-piece half can be attached.

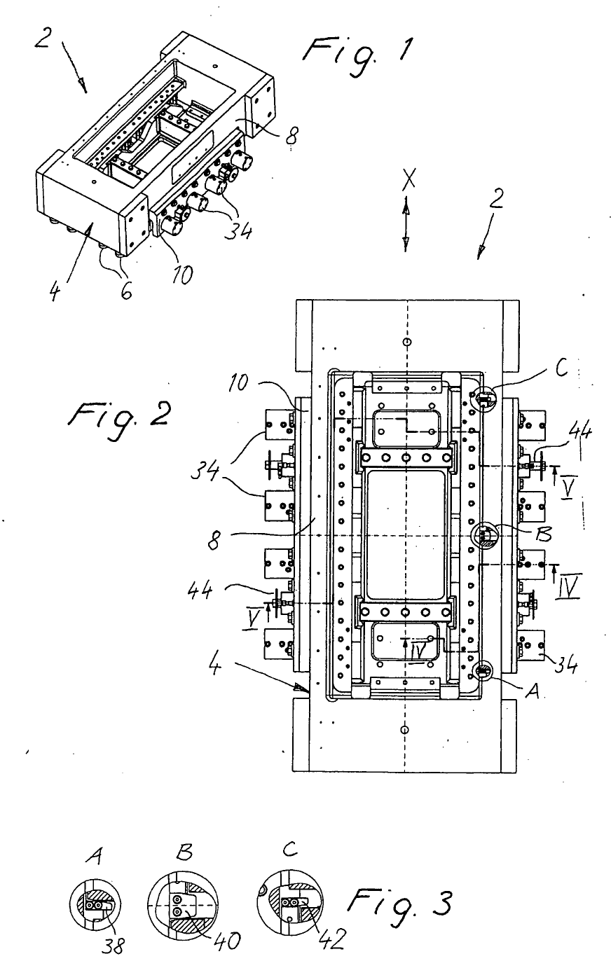

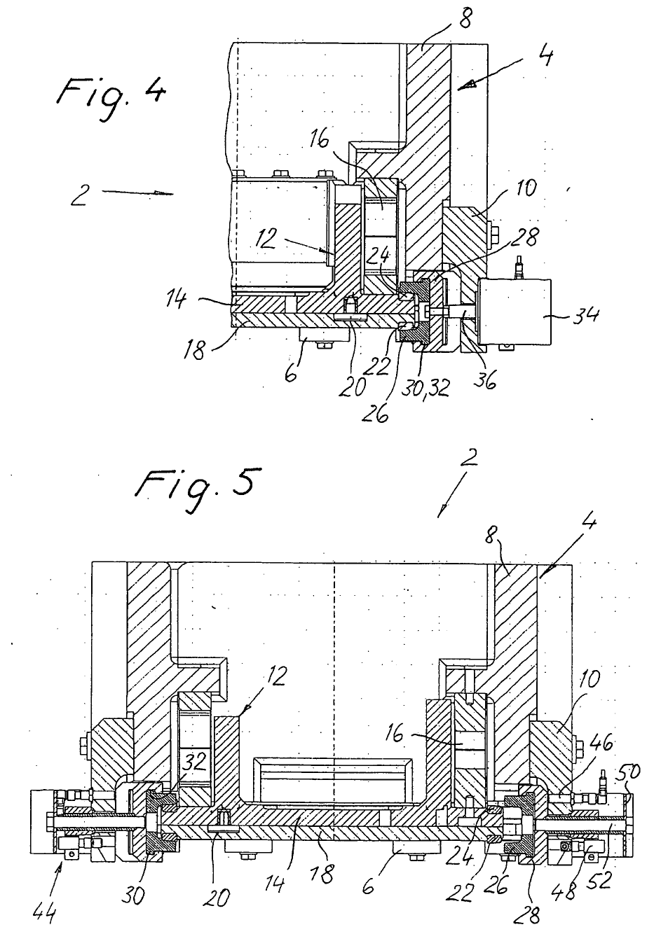

As already pointed out, the vibratory plate 14 and the tool plate 18 are part of a quick change device for quickly tightening and release the oscillating tool on the vibratory unit. The vibratory plate 14 and the tool plate 18 are of a substantially rectangular circumference (commensurate with the bridge 4 in FIGS. 1 and 2) and facing contact surfaces, with which they lie flat against each other in the position shown in FIGS. 4 and 5.

As shown in FIGS. 4 and 5, centering means 20 are provided, which position the vibratory plate 14 and the tool plate 18 with respect to each other in a predetermined orientation.

In the position shown in FIGS. 4 and 5, the vibratory plate 14 and the tool plate 18 can be clamped together using a mechanism, which will be described below.

Both the vibratory plate 14 and the tool plate 18 are provided with longitudinally running clamp bars 22 and 24 on their lateral, longitudinal edges running parallel to oscillation axis X, which are inserted into corresponding recesses in the vibratory plate 14 or the tool plate 18. The clamp bars 22, 24 are made of a harder material than the vibratory plate 14 or the tool plate 18. The clamp bars 22, 24 are preferably made of steel, while the vibratory plate 14 and the tool plate 18 are made of an aluminium alloy.

Longitudinally running, bar-shaped clamp bodies 26 are attached to the clamp bars 22 and 24 and thus to the longitudinal edges of the vibratory plate 14 and tool plate 18. As can be seen in FIGS. 4 and 5, the clamp bodies 26 have a cross-section in the approximate shape of a U, both legs of which can encompass the longitudinal edges of the vibratory plate 14 and the tool plate 18 and thereby clamp bars 22, 24 (see FIG. 4 and left side of FIG. 5).

The clamp bars 22, 24 have clamp surfaces on the exterior sides facing away from each other, which work together with the corresponding clamp surfaces on the interior of the legs of the U of the clamp body 26. If the clamp bodies 26 are retracted via the longitudinal edges of the vibratory plate 14 and the tool plate 18, then a clamp connection is established between the clamp surfaces of the clamp bodies 26 and the clamp bars 22, 24, whereby a force-fit connection is created between the vibratory plate 14 and the tool plate 18, as will be explained in greater detail. The clamp surfaces of the clamp bars 22, 24 and the clamp bodies 26 have an angle of inclination, which is smaller than the self-locking angle of the concerned materials, so that the clamp connection is self-locking. The angle of inclination is typically 5° or less and preferably lies in the region of 2 to 3°.

Instead of the embodiment shown, the clamp bars 22, 24 could be left off and the corresponding clamp surfaces could be provided directly on the vibratory plate 14 and the tool plate 18 provided that these plates are made of a correspondingly hard material.

The clamp bodies 26 are mounted in longitudinally running, bar-shaped holders 28. The holders 28 have a cross-section in the approximate shape of a U, the legs of which are provided with longitudinally running grooves 32 on their interiors. The clamp bodies 26 are provided with opposite-lying, longitudinally running protrusions 30, which are arranged in the grooves 32 of the holders 28 with a specified play.

The holders 28 are each firmly connected with several actuating devices. Based on the specified play between the clamp bodies 26 and the holders 28, each of the actuating devices are connected with the clamp bodies via a backlash connection, the purpose of which will be explained in greater detail.

In the exemplary embodiment shown, the actuating devices, which are arranged on the bridge 4, are made up of hydraulic cylinders 34, the piston rods 36 of which run through the frame part 10 of the bridge 4 and are attached to the holders 28. However, the actuating devices can be made up of other elements, such as motors.

The hydraulic cylinders 34 can be displaced between two end positions, namely between a clamping position and an opening position. In the clamping position, the hydraulic cylinders 34 push the clamp bodies 26 so that they abut in a clamped way against the clamp bars 22, 24, whereby the force-fit connection is established between the vibratory plate 14 and the tool plate 18 (FIG. 4 and the left side of FIG. 5). The resulting clamping force is greater than the expected breaking force of the oscillations during the welding process. In the opening position, the hydraulic cylinders 34 have removed the clamp bodies 26 from the clamp bars 22, 24 such that the force-fit connection between the vibratory plate 14 and the tool plate 18 is disconnected (right side of FIG. 5) so that the tool plate 18 can be removed downwards from the oscillating head 2.

Furthermore, the hydraulic cylinders 34 can move into an intermediate position, in which they are mechanically separated from the clamp bodies 26 and thus from the oscillating system due to the backlash connection (the play) between the clamp bodies 26 and the holders 28. However, the play between the clamp bodies 26 and the holders 28, which lies e.g. in the region of 1 mm, ensures that the hydraulic cylinders 34 in their intermediate position do not disconnect the clamp connection between the clamp bodies 26 and the clamp bars 22, 24. The tool plate 18 thus remains clamped with the vibratory plate, without transferring the oscillations of the vibratory unit 4 to the hydraulic cylinders 34.

In the exemplary embodiment shown, four actuating devices (hydraulic cylinders 34) are provided on each side of the oscillating head 2 (see FIGS. 1, 2). However, it is understood that the number of actuating devices can be changed depending on the requirements of special applications.

The clamp bodies 26 and the holders 28 can be designed in the longitudinal direction (parallel to the oscillation axis X) continuously and in one piece. However, in the exemplary embodiment shown, they are subdivided once transverse in the longitudinal direction (see FIG. 2). However, they can also be subdivided multiple times, which can be an advantage with respect to constructive requirements.

In order to fix the clamp bodies 26 in the longitudinal direction, end stops 38, 40, 42 are provided; they can be seen in FIG. 2 and are shown in greater detail in FIG. 3.

Sensors 44 are provided, which are attached to the holders 28 in the exemplary embodiment shown, in order to detect the clamping position and opening position of the actuating devices. For this purpose, sensor discs 50 are firmly attached to the holders 28 via connecting rods 52. Furthermore, the sensors 44 comprise pickup sensors 46 and 48 in the form of proximity changes. The pickup changes 46 work directly with the holders 28 to detect the opening position of the actuating devices (right side of FIG. 5). The pickup changes 48 work together with the sensor discs 50 to detect the clamped position of the actuating devices (left side of FIG. 5).

Operation of the described quick change device is explained in greater detail below.

It is assumed that the oscillating tool is affixed to the vibration head 2 so that the tool plate 18 is clamped with the vibratory plate 14 via the clamp bodies 26 (FIG. 4 and left side of FIG. 5). The following steps must be performed to exchange the oscillating tool (tool plate 18):

1. With the oscillating system switched off, the lift table (not shown) of the vibration welding machine is moved into its upper position, in which the oscillating tool (tool plate 18) is supported by the stationary tool (not shown).

2. The hydraulic cylinders 34 are moved into their opening position, and they take along the clamp bodies 26 via the holders 28, so that the clamp connection between the clamp bodies 26 and the clamp bars 22, 24 is released (right side of FIG. 5). The tool plate 18 is thus no longer connected with the vibratory plate 14, so that the oscillating tool lies loosely on the stationary tool.

3. The lift table is now moved downwards with both tools into a withdrawal position/home position.

4. After the stationary tool has been released, both tools are removed.

5. A new stationary tool and a new oscillating tool are inserted into the vibration oscillation machine and the stationary tool is affixed in a conventional manner.

6. The lift table is now moved into its upper position with the two new tools. The tool plate 18 of the oscillating tool then engages with the vibratory plate 14, wherein the centering means 20 ensure the positioning of the tool plate 18 in the specified alignment with the vibratory plate 14.

7. The hydraulic cylinders 34 are now moved into the clamping position, in which they push the clamp bodies 26 into clamped contact with the clamp bars 22, 24 via the holders 28. This creates a force-fit connection between the vibratory plate 14 and the tool plate 18 so that the oscillating tool is attached to the vibratory unit 12 of the oscillating head 2.

8. The hydraulic cylinders 34 are now moved back into their intermediate position, in which the holders 28 are mechanically separated from the clamp bodies 26. As already explained, this mechanical separation is achieved through the backlash connection between the clamp bodies 26 and the holders 28, more precisely through the play, with which the protrusions 30 of the clamp bodies 26 are arranged in the grooves 32 of the holders 28. The holders 28 and the hydraulic cylinders 34 are thereby decoupled from the clamp bodies and thus from the oscillating system, while the clamp connection between the clamp bodies 26 and the clamp bars 22, 24 is retained due to the self-locking.

9. After the lift table has been returned to its home position, the welding process can be executed, during which the vibratory plate 14 and the attached tool plate 18 execute the required oscillations without the oscillations being transferred to the actuating devices.

In the exemplary embodiment shown, the hydraulic cylinders 34 serve to both create and release the clamp connection between the clamp bodies 26 and the clamp bars 22, 24. This has the advantage of comparatively little construction effort. Another option is to use separate actuating devices (hydraulic cylinders) to establish and release the clamp connection. Constructively simpler actuating devices can be used for this solution.

In the exemplary embodiment shown, the adjacent contact surfaces of the vibratory plate 14 and the tool plate 18 are designed evenly. However, it is also possible to profile the contact surfaces such that, in addition to the force-fit connection, a positive-fit connection is established between the vibratory plate 14 and the tool plate 18. For example, the contact surfaces can be provided with ridges and depressions that run in the longitudinal direction parallel to the oscillation axis X.

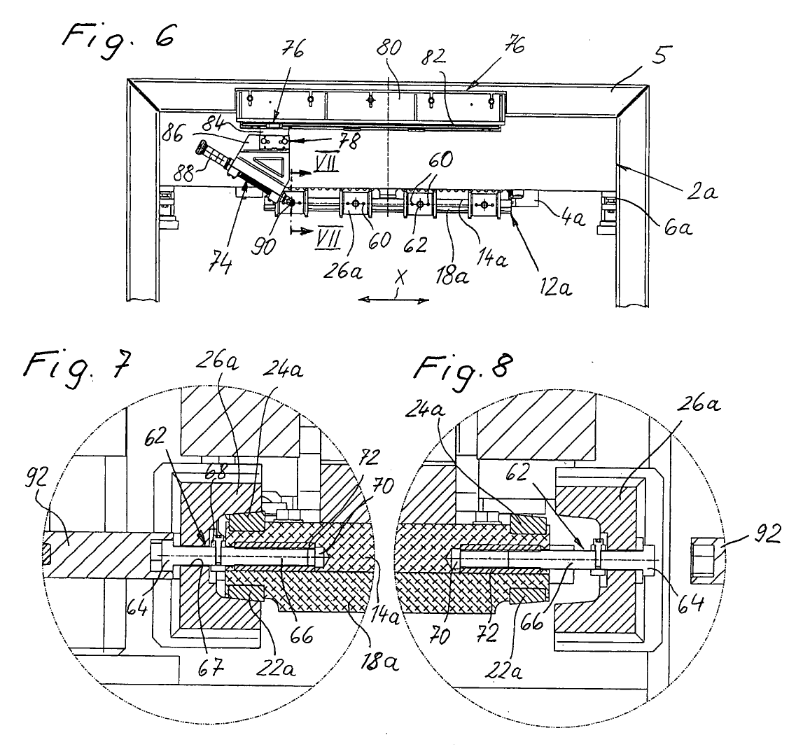

FIGS. 6 through 10 show a modified embodiment of the quick change device. Components similar to those of the previous embodiment were labelled with the same reference numbers with the addition of the letter a. Thus, the vibration head 2a in the embodiment in FIGS. 6 through 10 also comprises a bridge 4a, which is mounted on the machine frame 5 via dampers 6a, a vibratory unit 12a with a vibratory plate 14a as well as a tool plate 18, to which a work-piece-specific holder (not shown) for the oscillating work-piece half to be welded can be attached.

The vibratory plate 14a and the tool plate 18a are in turn provided with clamp bars 22a or 24a on their longitudinal edges, which are designed and arranged in the same manner as in the previous embodiment. In the embodiment shown, the clamp bars 22a, 24a are provided on longitudinal edges, which run parallel to the oscillation axis X. In lieu thereof, they could also run perpendicular to the oscillation axis X. Clamp bodies 26a, which have a cross-section in the approximate shape of a U, both legs of which can encompass the longitudinal edges of the vibratory plate 14a and the tool plate 18a and thereby the clamp bar 22a, 24a, are also attached to the clamp bars 22a and 24a. The clamp surfaces of the clamp bars 22a, 24a and the clamp bodies 26a and the clamp connection formed by them are designed in the same manner as in the previous exemplary embodiment.

In the embodiment in FIGS. 6 through 10, each side of the vibratory unit 12a is provided with four clamp bodies 26a, which are laterally spaced from each other (FIG. 6). While the clamp bodies in the previous exemplary embodiment are attached to a stationary part of the vibration welding machine (machine frame or bridge), they are attached to the vibratory unit 12a in the exemplary embodiment in FIGS. 6 through 10. For this purpose, the clamp bodies 26a can be attached in a moveable manner by means of guide pins 60, which are received by bore holes (not shown) of vibratory plate 14a (FIGS. 6, 9, 10). As can be seen in particular in FIGS. 9 and 10, each clamp body 26a is provided with two guide pins 60, which are screwed to the clamp bodies 26a. However, in principle, the guide pins could also be provided on the vibratory plate 14a.

Instead of the hydraulic cylinders of the previous exemplary embodiment, the actuating devices in the exemplary embodiment in FIGS. 6 through 10 comprise screws 62, which serve to tighten and release the clamp bodies 26a. Each of the screws 62 comprises a head 64 and a shaft 66. The shaft 66 extends through a centrally arranged through hole 67 of a clamp body 26a and is connected with it on one side by the head 64 and on the other side by a stop 68, such that the screw 62 can take along the associated clamp body in both axial directions in the case of an axial movement.

The threaded part of the shaft 66 of the screw 62 is disposed in a corresponding hole 70 of the vibratory plate 14a. More precisely, the thread of the shaft 66 is engaged with the thread of a threaded bushing 72, which is arranged within the bore hole 70. The screw 62 can thus be moved axially through a screw movement relative to hole 70 in order to be able to displace the associated clamp body between its clamping and opening position.

Screwdrivers 74, which are integrated into the vibration welding machine, serve to actuate the screws 62. In the exemplary embodiment shown, a screwdriver 74 associated with each of the screws 62 of the four clamp bodies 26a on the opposed sides of the oscillating head 2a; it can be used to tighten and release each of the screws 62 on the associated side of the vibration head 2a by means of two linear guides 76 and 78 (FIG. 6).

The linear guide 76 runs parallel to the oscillation axis X and serves to move the screwdriver 74 longitudinally along a first traverse axis in order to be able to approach the positions of the four clamp bodies 26a and their associated screws 62. The linear guide 76 is formed by a holder 80 with a rail 82 attached to the machine frame 5, on which a support part 84 is guided in a sliding manner.

The linear guide 78 runs at a right angle to the linear guide 76 in order to be able to move the screwdriver 74 longitudinally along the traverse axis, which runs parallel to the axes of the screws 62. Due to the linear guide 78, the screwdriver 74 of the axial movement of a screw 62 can thus follow during tightening and release. The linear guide 78 is formed between the support part 84 of the linear guide 76 and a support part 86, to which the screwdriver 74 is attached.

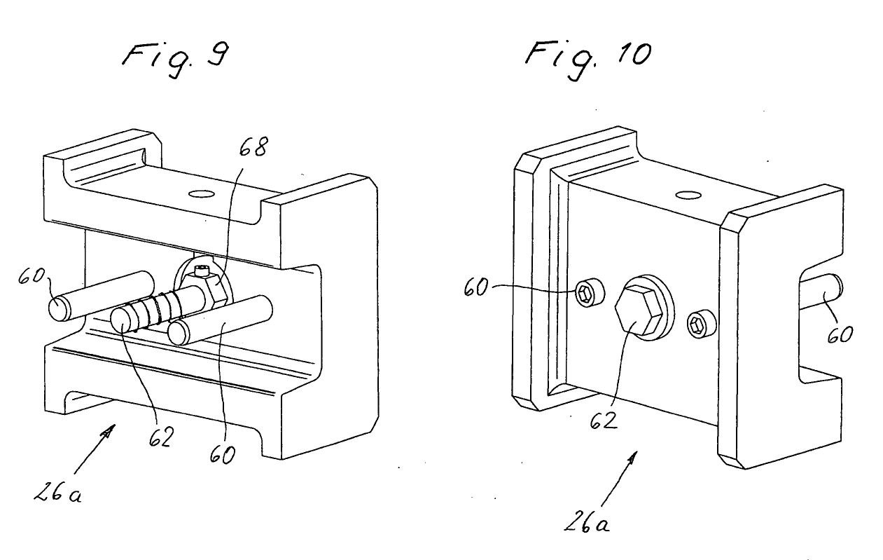

A conventional, controllable screwdriver can be used as screwdriver 74 provided that the required precision and the required torque can be achieved. As shown schematically, the screwdriver 74 is provided with a drive 88, which is designed electrically, pneumatically, hydraulically or in another suitable manner. Furthermore, the screwdriver 74 is provided with an elbow fitting 90 so that a socket wrench 92 (FIGS. 7, 8).provided on the elbow fitting 90 can grip the head 64 of an associated screw 62. The screwdriver 74 can thereby be arranged in a position, in which its main axis runs perpendicular to the screw axes.

The linear guides 76 and 78 are each provided with a drive (not shown) for displacing the screwdriver 74 longitudinally along the corresponding traverse axis. The drives can be actuated in a conventional manner electrically, pneumatically, hydraulically or in another manner.

Operation of the quick change device in the exemplary embodiment in FIGS. 6 through 10 will now be described:

In order to create the clamp connection between the vibratory plate 14a and the tool plate 18a, the screws 62 are tightened with the help of the screwdrivers 74. For this purpose, the two opposite-lying screwdrivers 74 are first moved into a position, in which the socket wrench 92 of the associated screwdriver 74 aligns with the axis of the screw 62 to be actuated, with the help of the liner guides 76. With the help of the linear guide 78, the screwdriver 74 is then moved at a right angle to the traverse axis of the linear guide 76 such that the socket wrench 92 receives the head 64 of the associated screw 62. The screwdriver 74 is now actuated in order to screw the screw deeper into the bore hole 70 of the vibratory plate 14a. The screw 62 thereby takes along the associated clamp body 26a, so that the clamp surfaces of the clamp body 26a engage with the clamp surfaces of the clamp bars 22a, 24a.

The other screws 62 are also tightened in this manner. A clamp connection is then established between the vibratory plate 14a and the tool plate 18a, which is also self-locking, in the same manner as in the previous embodiment. The screws 62 serve as additional safeguards, which prevent the unintentional release of the clamp connection through undesired or undefined impacts (e.g. impact loads). FIG. 7 shows the clamp connection in a closed state.

The above steps are performed in the opposite sequence to release the clamp connection. After the screwdriver 74 has approached a screw to be released 62 via the linear guide 76 and 78, the concerned screw 62 is unscrewed from the bore hole 70 using screwdriver 74. The screw 62 thereby takes along the associated clamp body 26a via the stop 68. The clamp body 26 is thereby moved such that the tool plate 18a can be removed from the vibratory plate 14a, as was described based on the previous exemplary embodiment. The clamp body 26a is held on the vibratory plate 14a by the guide pins 60 and the screw 62.

Once the screwdriver 74 has released all clamp bodies 26a in this manner, the socket wrench 92—with the help of the linear guide 78—is removed from the screw head 64 so that the screwdriver 74 is decoupled from the vibratory unit 12a. This state is shown in FIG. 8. During the vibration welding process, i.e. during the oscillation of the vibratory unit 12a, the socket wrench 92 is always removed from the screws 62 and thus decoupled. As shown in FIG. 6, the screwdrivers 74 are mounted to the machine frame 5 via the linear guides 76 and 78. Mounting on the bridge 4a, which is less impacted by the oscillations, would also be possible.

As already mentioned, two screwdrivers 74, each of which is associated with four clamp bodies 26a on opposite-lying sides of the oscillating head 2a, are provided in the embodiment shown.

However, another embodiment (not shown) is also possible, in which a separate screwdriver is provided for each screw 62. The linear guide 76 for approaching the different screws would then be omitted. In the embodiment shown here, eight screwdrivers would then be required, each of which would be associated with one linear guide 78 for displacing the screwdriver 74 parallel to the screw axes. The time-saving advantage would then offset the disadvantage of the higher costs, since all screws and thus all clamp bodies could be tightened and released at the same time.

In another embodiment not shown here, screwdrivers and linear guides can be omitted altogether. In this case, the screws 62 are tightened and released manually using a torque wrench. Since relatively few screws need to be actuated in this embodiment due to the use of the clamp bodies, the clamp connection between the vibratory plate 14a and the tool plate 18a can be opened and closed comparatively quickly, so that this solution also saves a considerable amount of time despite minimum production costs. Thus, this manual quick change device also has its advantages in comparison with the previously explained fully automatable quick change devices.

We claim:

1. Quick change device for a tool that can be attached to a vibratory unit of a vibration head of a vibration welding machine for receiving a work-piece half to be welded, comprising
a vibratory plate, which is part of the vibratory unit and is suspended via springs on a bridge of the vibration head, in order to be able to execute oscillations along a specified oscillation axis X,
a tool plate, which is part of the tool,
at least two clamp bodies, which are mounted in a movable manner on the vibration machine, and
actuating devices for displacing the clamp bodies,
wherein the actuating devices are displaceable between a clamping position, in which the clamp bodies establish a force-fit connection between the vibratory plate and the tool plate, and an opening position, in which the clamp bodies release the force-fit connection.

2. Quick change device according to claim 1, wherein the force-fit connection between the vibratory plate and the tool plate is designed so as to be self-locking.

3. Quick change device according to claim 1, wherein the at least two clamp bodies engage opposed longitudinal edges of the vibratory plate and tool plate that run parallel to the oscillation axis X.

4. Quick change device according to claim 3, wherein the clamp bodies have a cross-section in the approximate shape of a U, the legs of which encompass, in the clamping position, the longitudinal edges of the oscillation plate and tool plate.

5. Quick change device according to claim 4, wherein the clamp bodies, on the interiors of the legs of the U clamp surfaces, and the vibratory plate and the tool plate, in the area of their longitudinal edges, have corresponding clamp surfaces which are inclined at a specified angle of inclination and cooperate to produce the force-fit connection between the vibratory unit and tool plate.

6. Quick change device according to claim 5, wherein the angle of inclination of the clamp surfaces is smaller than the self-locking angle of the concerned materials.

7. Quick change device according to claim 5, wherein the clamp surfaces of the vibratory plate and the tool plate are provided on clamp bars, which are inserted in the vibratory plate and tool plate and the material of which is harder than the material of the vibratory unit and tool plate.

8. Quick change device according to claim 1, wherein the clamp bodies are mounted on the vibratory unit in a movable manner.

9. Quick change device according to claim 8, characterized in that guide pins serve to mount the clamp bodies on the vibratory unit in a movable manner.

10. Quick change device according to claim 8, wherein the actuating devices comprise screws, which are screwed into holes of the vibratory unit and are connected with the clamp bodies for tightening and releasing the clamp bodies when they are actuated.

11. Quick change device according to claim 10, wherein the screws serve to ensure the force-fit connection between the vibratory plate and the tool plate through the clamp bodies.

12. Quick change device according to claim 10, wherein the screws are adapted to be actuated manually.

13. Quick change device according to claim 10, wherein at least one screwdriver, which is mounted on the bridge or directly on the machine frame, is provided for actuating the screws.

14. Quick change device according to claim 13, wherein the screwdriver has a socket wrench for gripping a head of the screw.

15. Quick change device according to claim 13, wherein the screwdriver is supported by a linear guide so as to enable the screwdriver to follow a linear movement of the screw during tightening and release thereof.

16. Quick change device according to claim 13, wherein a separate screwdriver is provided for each screw.

17. Quick change device according to claim 13, wherein on each side of the vibratory unit to which a clamp body is attached there is provided a screwdriver, which can be moved to the screws provided on the respective side by means of a linear guide.

18. Quick change device according to claim 1, wherein the clamp bodies extend substantially over the entire length of the vibratory plate and tool plate parallel to the oscillation axis X.

19. Quick change device according to claim 1, wherein the clamp bodies are subdivided at least once in a transverse direction.

20. Quick change device according to claim 1, wherein the vibratory plate and the tool plate lie flat against each other in the clamping position.

21. Quick change device according to claim 20, wherein the vibratory plate and the tool plate can be positioned in predetermined orientation with respect to each other through centering means.

22. Quick change device according to claim 1, wherein the adjacent surfaces of the vibratory plate and the tool plate are profiled such that, in addition to the force-fit connection, a positive connection is present between them.

23. Quick change device according claim 1, wherein sensors are provided for detecting the clamping and opening positions of the actuating devices.
